(19) United States
(12) Patent Application Publication
(10) Pub. No.: US 2017/0318121 A1
(43) Pub. Date: Nov. 2, 2017

(54) SERVER REQUEST HANDLERS

(71) Applicant: HEWLETT PACKARD ENTERPRISE DEVELOPMENT LP, Houston, TX (US)

(72) Inventor: Joseph Miller, Boulder, CO (US)

(73) Assignee: HEWLETT PACKARD ENTERPRISE, Fort Collins, CO (US)

(21) Appl. No.: 15/143,447

(22) Filed: Apr. 29, 2016

(51) Int. Cl. H04L 29/08; H04L 29/06

(52) U.S. Cl. CPC H04L 67/327; H04L 69/28; H04L 67/1034; H04L 67/42

(57) ABSTRACT

A server including request handlers each having a unique handler identifier. The server receiving client service requests, each client service request including a handler identifier, and for each client service request, selecting the request handler corresponding to the handler identifier. The selected request handler implements a predefined procedure to process the client service request including to send a handler service request to a destination server initially selected from a predetermined group of destination servers, the handler service request including a handler identifier, and to receive a response message, including response data, from the initially selected destination server in response to the handler service request. Based on the response data, the predefined procedure to send a reply message to the client, or to send a new handler service request to a destination server newly selected from the predetermined group of destination servers, the new handler service request including a handler identifier.

### BACKGROUND

Clients seeking services or resources from other servers often submit requests to a proxy server which acts as an intermediary between the client and other servers.

### BRIEF DESCRIPTION OF THE DRAWINGS

FIG. 1 is a block and schematic diagram illustrating a server having request handlers according to one example of the present disclosure.

FIG. 2 is a block and schematic diagram illustrating a server having request handlers according to one example of the present disclosure.

FIG. 3 is an example of configuration data according to one example of the present disclosure.

FIG. 4 is a flow diagram illustrating generally a method of operating a server employing request handlers in accordance with the present disclosure.

FIG. 5 is a flow diagram illustrating generally a method of operating a server employing request handlers in accordance with the present disclosure

FIG. 6 is a block and schematic diagram generally illustrating a server implementing a correlator, request handlers, and configuration data for request handling, in accordance with one example of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Clients seeking services or resources from other servers often submit requests to a proxy server which acts as an intermediary between the client and other servers. However, such proxy servers may merely relay messages between the client and the destination server and provide no assistance in processing of the client request.

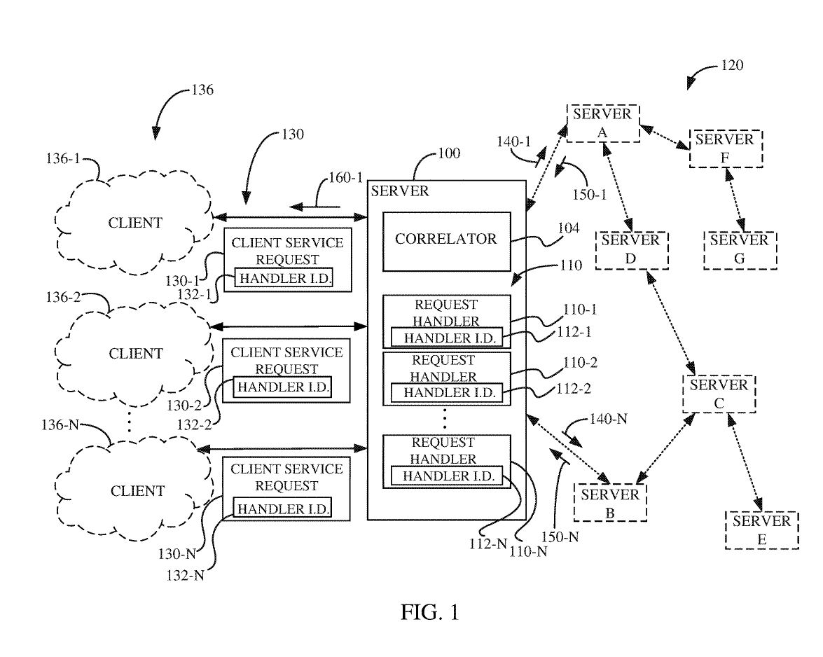

FIG. 1 is a block and schematic diagram generally illustrating and describing a server 100, in accordance with the present disclosure, having request handlers employing predefined procedures to process client requests, including sending requests to and receiving responses from other similarly configures servers in the processing of the client request, where the processing of the client request according to the predefined procedure is invisible to the client. According, rather than simply serving as pass-through for client request, server 100 in accordance with the present application carries out a predefined procedures to process the client request.

According to one example, as illustrated, server 100 includes a correlator 104 and a plurality of request handlers 110, illustrated as request handlers 110-1 to 110-N, with each request handler having a unique handler identifier, illustrated as handler identifiers 112-1 to 112-N. Server 100 is in communication with a network of destination servers 120, such as destination servers A to F, with each of the destination servers A to F being configures similarly to server 100, as will be described in greater detail below. Although illustrated as including only destination servers A-F, any number, N, of destination servers may be included in the network of destination servers 120. Destination servers 120 may be under common management and ownership, or may be separately owned, managed and operated, such as in different clouds, for example.

Correlator 104 receives client service requests 130 from a plurality of clients 136, such as client service requests 130-1 to 130-N from clients 136-1 to 136-N. Each client service request includes a handler identifier 132, illustrated as handler identifiers 132-1 to 132-N. According to one example, for each client service request 130, correlator 104 selects the request handler 110 having a request identifier 112 corresponding to the handler identifier 132 of the client service request 130, and forwards the service request 130 to the selected request handler 110. For example, if handler identifier 132-1 of client service request 130-1 corresponds to handler identifier 112-N of request handler 110-N, correlator 104 forwards client 136-1 to request handler 110-N for processing.

Upon receipt of a forwarded client service request 130, the corresponding request handler 110 implements a predefined procedure to process the client service request 130. In one example, as will be described in greater detail below, each request handler 110 includes a predefined procedure for processing a pre-defined service and includes a predetermined group of destination servers of network 120 to access when processing of the pre-defined service. According to one example, when seeking processing of a given pre-defined service, a client 136 submits a client service request 132 including the handler identifier 132 corresponding to the request handler 110 having the pre-defined procedure for processing the given pre-defined service sought by client 136.

In one example, to implement a predefined procedure to process a client service request 132, request handler sends a handler service request 140 to a destination server initially selected from the associated pre-determined group of destination servers of the network of destination servers 120, such as handler service request 140-1 to destination server A, the handler service request 140 (including handler service request 140-1) also including a handler identifier. The selected request handler 110 receives a response message 150, including response data, from the initially selected destination server, such as response message 150-1 from destination server A. In one example, the response data, includes various data from the selected destination server including success, failure, and timeout responses, for example. In one example, each handler service request 140 and each response message 150 is mapped by request handler 110 to the client service request.

In one example, based on the response data, the predefined procedure of selected request handler 110 sends a reply message 160 to the requesting client 136, such as reply message 160-1, or sends a new handler service request 140 to a destination server newly selected from the predetermined group of destination servers of the network of destination servers 120, such as handler service request 140-N to destination server B, handler service request 140-N also including a handler identifier. A reply message, such as reply message 160 may include response data representative of a desired answer to the client service request, or may include data indicating that the client service request was unsuccessfully processed (e.g., failed to process, partially processed).

As a demonstrative example, assume client 136-1 seeks to determine the current temperature at the client's location. Client 136-1 knows that request handler 136-N has a predefined procedure for determining a current temperature, and sends client service request 130-1 to server 100, with client service request 130-1 including handler identifier 132-1 corresponding to handler identifier 112-N of request handler 110-N. Correlator 104 receives client service request 130-1 and, based on handler identifier 132-1, forwards client service request 130-1 to request handler 110-N.

In one example, the associated group of destination servers associated with request handler 110-N includes destination servers A, B, and F. Upon receiving client service 130-1, request handler 110-N implements its predetermined procedure for determining a current temperature. In one example, according to the predetermined procedure of request handler 110-N, server A is known to include a request handler for finding a current temperature. Request handler 110-N selects server A as the initial destination server and sends handler request 140-1 including a handler identifier corresponding to the handler identifier of the current temperature request handler of server A. In response, server A sends response message 150-1, including response data, to request handler 110-N.

The predefined procedure of request handler 110-N, based on the response data of response message 150-1 determines how to proceed. In one example, for instance, the response data may represent a temperature as measured in degrees Fahrenheit. However, the predefined procedure of request handler 110-N is configured to provide a current temperature in degrees Celsius. In one example, according to the predefined procedure of request handler 110-N, server B is known to include a request handler for converting degrees Fahrenheit to degrees Celsius. Request handler 110-N newly selects server B as the destination server and sends handler request 140-N including a handler identifier corresponding to the handler identifier of the Fahrenheit-to-Celsius request handler of server B. In response, server B sends response message 150-N, including response data, to request handler 110-N.

In one example, the predefined procedure of request handler 110-N, based on the response data of response message 150-N determines that it is complete and that a current temperature in degrees Celsius has been determined. According to one example, in such case, request handler 110-N sends a client reply message 160-1 to client 136-1 including the determined temperature.

In another example, the response data of initial response message 150-1 may indicate that the server A failed to determine a current temperature. In such case, according one example, the predefined procedure of request handler 110-N, rather than sending a new handler service request to server B, may re-select server A as the destination and send a new handler request to server A requesting a server A. If the response from server A again returns response data indicating failure to determine a current temperature, data handler 110-N may send client response message 160-1 informing client 136-1 that a current temperature has not been determined.

The above examples are for illustrative purposes, and any number of scenarios can be imagined. For example, request handlers 110 may include predefined procedures to perform and any number of processes or functions, with each predefined procedure determining differently, based on response data, as when the procedure has been completed and a client response message is to be sent to the client.

By employing request handlers to implement predefined procedures to process a client request, including sending and receiving handler requests and response messages to and from predefined groups of destination servers, server 100 in accordance with the present disclosure, rather than simply serving as a relay for client requests, performs the requested service by the client, with such performance (including communication with destination servers) being opaque to the client. Such processing of client requests in accordance with the present disclosure provides unique servers, methods of operating servers, and computer-readable media in servers that are not generic computers and that improve the server itself and the system of clients and servers as a whole.

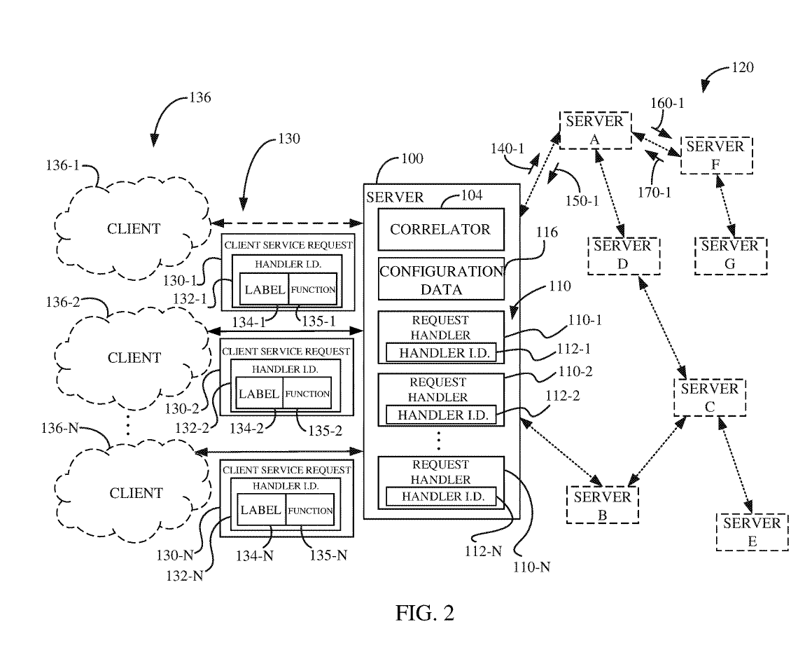

FIG. 2 is a block and schematic diagram illustrating server 100 according to one example. As illustrated by FIG. 2, in addition to a request handler 110 of server 100 providing a handler request to a destination server and receiving a response message therefrom, such as request handler 140-1 and response message 150-1 to/from destination server A, for example, a destination server may itself send/receive handler requests/response messages from further destination servers. For example, continuing with the illustrative example above, where request handler 110-N may send handler request 140-1 to a given request handler of server A, the given request handler of server A may, in-turn, send a handler request to a response handler of another server, such as handler request 160-1 to server F, for example. The response handler of server F, in-turn, provides a response message 170-1 to server A, with server A employing response data of response message 170-1 to determine response message 150-1 to request handler 110-N of server 100.

In one case, as illustrated, handler identifiers 132 of client service requests 130 include a label 134 and a function name 135, illustrated as labels 134-1 to 134-N and function names 135-1 to 135-N with respect to client service requests 130-1 to 130-N. In one example, function name 135 is an identifier defining a service (e.g., determine a current temperature in terms of the example above), and label 134 is identifier that, when used in conjunction with function name 135, provides a unique handler identifier 132 for each request handler 110.

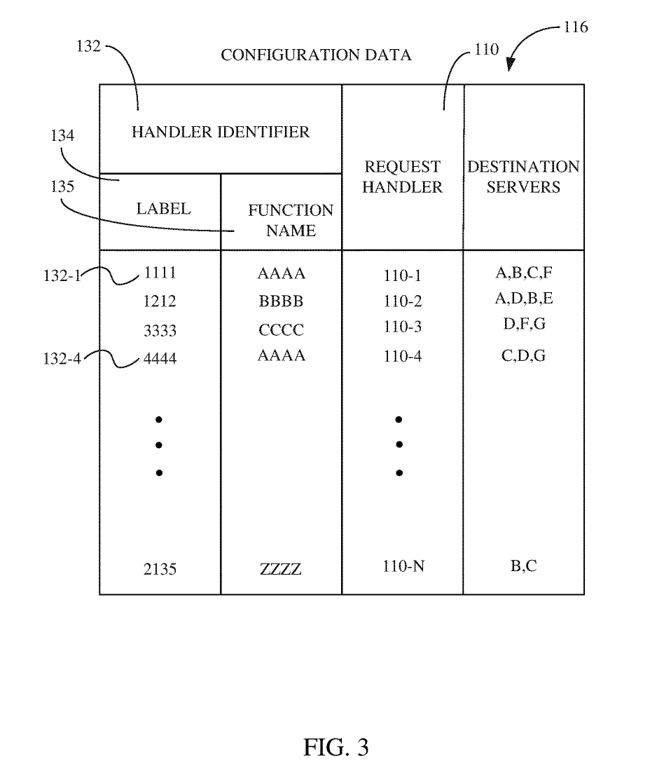

In one example, server 100 further includes configuration data 116 representative of a configuration of request handlers 110. With reference to FIG. 3, according to one example, configuration data 116 includes a look-up table 116 which is referenced by correlator 104 to select request handlers 110 based on handler identifiers 132 included with received client service requests 130. In one example, as illustrated, look-up table 116 includes a label and function name corresponding to each request handler 110-1 to 110-N. Additionally, in one example, look-up table 116 indicates the predefined groups of destination servers associated with each request handler 110 and which the request handler may access to implement its predefined procedure.

As an example, handler identifier 132-1 corresponding to request handler 110-1 includes a label “1111” and a function name “AAAA” where, as described above, function name “AAAA” may indicate a service for determining a current temperature, for example. In one example, configuration table 116 further indicates the predefined groups of destination servers associated with request handler 110-1, destination servers “A”, “B”, “C”, and “F”, according to the illustrated example. Note that request handler 110-4, corresponding to handler identifier 132-4 having label “4444” and function name “AAAA”, performs a same function as request handler 110-1. However, whereas request handler 110-1 has an associated predefined group of destination servers including destination servers “A”, “B”, and “F”, request handler 110-4 has an associated predefined group of destination servers including destination servers “C”, “D”, and “G”. As a result, even though request handlers 110-1 and 110-4 have predetermined procedures to perform the same function “AAAA” (e.g., determine current temperature), because each has a different predefined group of destination servers, request handler 110-1 and 110-4 may return different results for a same function. For example, client 136-1 may have a higher level service agreement than client 136-2, with client 136-1 having access to request handler 110-1 (and thus employing handler identifier 132-1 having label “1111” and function name “AAAA”), which provides superior results to request handler 110-4 to which client 136-2 has access (employing handler identifier 132-4 having label “4444” and function name “AAAA”).

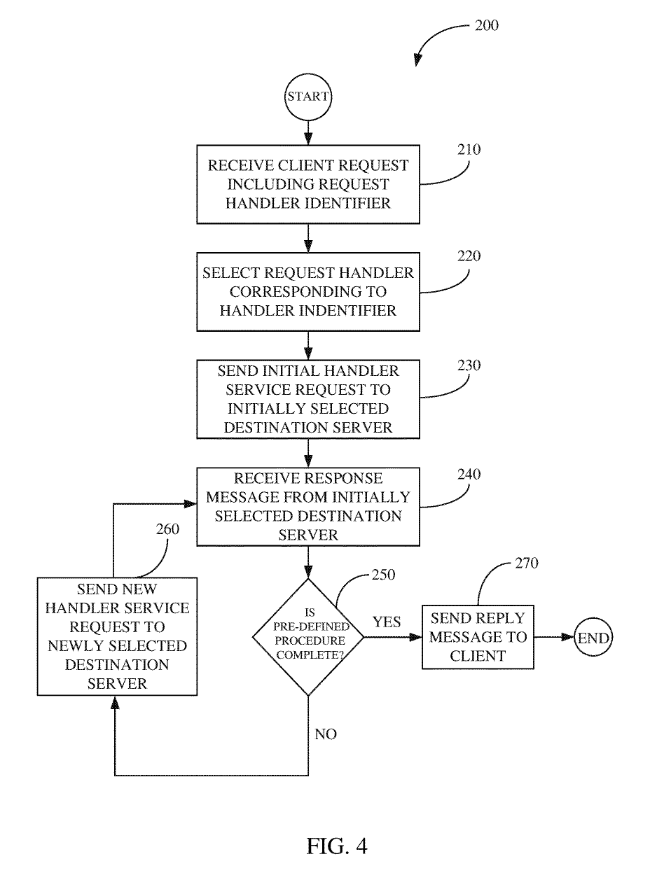

FIG. 4 is a flow diagram generally illustrating a method 200 of operating a server including request handlers, in accordance with the present application, such as server 100 of FIGS. 1 and 2. At 210, method 200 includes the server receiving client service requests, with each client service request including a handler identifier, such as correlator 104 of server 100 of FIGS. 1 and 2 receiving client service requests 130 including handler identifiers 132. At 220, method 200 includes selecting, for each client service request, a request handler corresponding to the handler identifier, such as correlator 104 of server 100 of FIGS. 1 and 2 selecting a request handler 110 having a handler identifier 112 corresponding to handler identifier 132 of a client service request 130.

At 230, method 200 includes the selected request handler processing the client service request by implementing a predefined procedure including the selected request handler processing the client service request by implementing a predefined procedure sending a handler service request to a destination server initially selected from a predetermined group of destination servers associated with the request handler, such as request handler 110-N sending a handler request 140-1 to server A (e.g., when implementing a predetermined process to determine a current temperature), as illustrated by FIG. 1.

At 240, method 200 includes receiving a response message, including response data, from the initially selected destination server, such as receiving request handler 110-N of server 100 receiving response message 150-1 from server A, as described above with respect to FIG. 1, for example.

At 250, method 200 queries, based on the response data of the response message, whether the pre-defined procedure for processing the client request is complete. Whether a pre-defined procedure is complete depends on the pre-defined procedure of a given request handler. For example, the response data from the response message may indicate a successful response, but yet the pre-defined procedure may not be determined to be complete. For example, as described above by FIG. 1 with respect to request handler 110-N, a successful response for a current temperature via response message 150-1 from destination server A was deemed to not be complete as such current temperature was in units of degrees Fahrenheit rather than degrees Celsius. The pre-defined procedure may not be deemed not complete for any number of reasons (e.g., the response message indicated a failed response, response data was successful but incomplete). When an answer to the query at 250 is no (i.e., the predefined procedure is deemed to not be complete), method 200 proceeds to 260.

At 260, based on the response data, method 200 determines what is required to complete the pre-defined procedure and selects a new destination server from the predefined group of destination servers associated with the particular data hander and sends a new handler request message to a request handler of the newly selected destination server having a predetermined procedure to provide response data including information required to complete the predefined procedure. For example, as described above with respect to FIG. 1, with respect to request handler 110-N, upon receiving response message 150-1 including a current temperature in degrees Fahrenheit, the predefined procedure of request handler 110-N determines that the temperature needs to be in degrees Celsius, and sends a new handler request to a request handler of server B (which includes a request handler for converting degrees Fahrenheit to degrees Celsius, for example). In one example, method 200 then iteratively repeats 240, 250 and 260 until the pre-defined procedure, based on response data from response messages received at 240, has deemed itself to be completed. For example, a pre-define procedure may deem itself to be complete after a preset number of iterations have been completely without the successful response having been achieved for the client request.

If the answer to the query at 250 is yes (i.e., the pre-defined procedure has deemed itself to be complete), method 200 proceeds to 270, where a client reply message is provided to the client 136 from who the client service request was received (for example, client reply message 160-1 sent to client 136-1 by request handler 110-N as described above by FIG. 1. The client reply message may communicate any number of difference responses the client 136, including a successful response and a response indicative of a failed attempt to process the client service response. For example, the client reply message at 270 may indicate that a current temperature was successfully determined, such as client reply message 160-1 of FIG. 1 provided to client 136-1 by request handler 110-N. After sending a reply message to the client, such as response message 160-1 to client 136-1, for example, method 200 is complete.

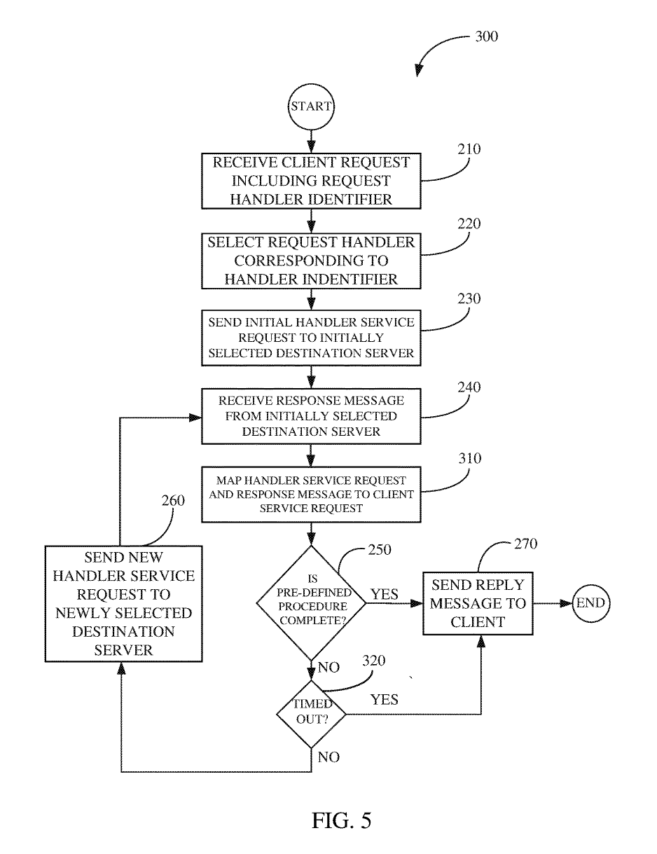

FIG. 5 is a flow diagram generally illustrating a method 300 of operating a server including request handlers, in accordance with the present application, such as server 100 of FIGS. 1 and 2. Method 300 is similar to method 200 of FIG. 4, but further includes 310 and 320, with the identical label numbers from method 200 of FIG. 4 describing similar actions with regard to method 300.

In one example, as illustrated, 310 occurs between 240 and 250, and includes a request handler 110 for a given client service request 230 mapping each handler service request and each response message from a destination server to the client service request. For example, continuing with the above described example, request handler 110-N of FIG. 1 maps handler service requests 140-1 and 140-N, and associated response messages 150-1 and 150-N to the client request 130-1, for instance.

In one example, method 300 includes 320, which occurs immediately following 250, and includes determining whether a predetermined duration has elapsed. According to one example, method 300 will iteratively repeat 250, 260, and 240 until the predefined duration has elapsed, at which point the predefined process will be deemed to have timed out, and a reply message indicating such a timeout will be provided to the client at 270.

In one example, each of correlator 104, request handlers 110, and configuration data 116 may be implemented in any combination of hardware and programming within server 100, or within another computing system, or some combination thereof, to implement the functionalities of correlator 104, request handlers 110, and configuration data 116, as described herein in relation to any of FIGS. 1-6. For example, correlator 104, request handlers 110, and configuration data 116 may be implemented as processor executable instructions stored on at least one non-transitory machine-readable storage medium and hardware may include at least one processing resource to execute the instructions. According to such examples, the at least one non-transitory machine-readable storage medium stores instructions that, when executed by the at least one processing resource, implement correlator 104, request handlers 110, and configuration data 116.

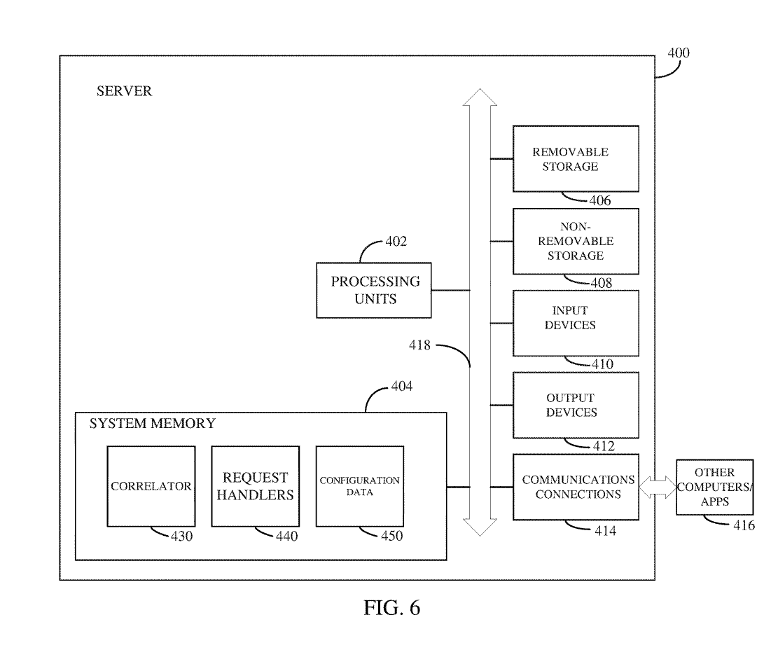

FIG. 6 is a block and schematic diagram generally illustrating a server 400 implementing correlator 104, request handlers 110, and configuration data 116 for request handling, in accordance with one example of the present disclosure. In the illustrated example, server 400 includes processing units 402 and system memory 404, where system memory 404 may be volatile (e.g., RAM), non-volatile (e.g., ROM, flash memory, etc.), or some combination thereof. Server 400 may also have additional features/functionality and additional or different hardware. For example, computing device 400 may include input devices 410, output devices 412, and communication connections 414 that allow server 400 to communicate with other computers/applications 416, wherein the various elements of server 400 are communicatively coupled together via communication links 418.

In one example, server 400 may include additional storage (removable and/or non-removable) including, but not limited to, magnetic or optical disks or tape. Such additional storage is illustrated in FIG. 6 as removable storage 406 and non-removable storage 408. Computer storage media includes volatile and nonvolatile, removable and non-removable media implemented in any suitable method or technology for non-transitory storage of information such as computer readable instructions, data structures, program modules, or other data, and does not include transitory storage media. Computer storage media includes RAM, ROM, EEPROM, flash memory or other memory technology, CD-ROM, digital versatile disks (DVD) or other optical storage, magnetic cassettes, magnetic tape, and magnetic disc storage or other magnetic storage devices, for example.

System memory 404, removable storage 406, and non-removable storage 408 represent examples of computer storage media, including non-transitory computer readable storage media, storing computer executable instructions that when executed by one or more processors units of processing units 402 causes the one or more processors to perform the functionality request handling as provided by correlator 104, request handlers 110, and configuration data 116. For example, as illustrated by FIG. 6, system memory 404 stores computer executable instructions 420 for correlator 104, 430 for request handlers 110, and 440 for configuration data 450, that when executed by one or more processing units of processing units 402 implement the functionalities of correlator 104, request handlers 110, and configuration data 116 as described herein. In one example, one or more of the at least one machine-readable medium storing instructions for at least one of correlator 104, request handlers 110, and configuration data 116 may be separate from but accessible to server 200. In other examples, hardware and programming may be divided among multiple computing devices.

In some examples, the computer executable instructions can be part of an installation package that, when installed, can be executed by the at least one processing unit to implement the functionality of at least one of correlator 104, request handlers 110, and configuration data 116. In such examples, the machine-readable storage medium may be a portable medium, such as a CD, DVD, or flash drive, for example, or a memory maintained by a server from which the installation package can be downloaded and installed. In other examples, the computer executable instructions may be part of an application, applications, or component already installed on server 200, including the processing resources. In such examples, the machine readable storage medium may include memory such as a hard drive, solid state drive, or the like. In other examples, the functionalities of at least one of correlator 104, request handlers 110, and configuration data 116 may be implemented in the form of electronic circuitry.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A server comprising:
a plurality of request handlers each having a unique handler identifier; and
a correlator to receive client service requests, each client service request including a handler identifier, for each client service request, the correlator to select the request handler corresponding to the handler identifier, the selected request handler to implement a predefined procedure to process the client service request including to:
send a handler service request to a destination server initially selected from a predetermined group of destination servers, the handler service request including a handler identifier;
receive a response message, including response data, from the initially selected destination server in response to the handler service request; and
based on the response data:
send a reply message to the client; or
send a new handler service request to a destination server newly selected from the predetermined group of destination servers, the new handler service request including a handler identifier.

2. The server of claim 1, the newly selected destination server is the same as the initially selected destination server.

3. The server of claim 1, the newly selected destination server is different from the initially selected server.

4. The server of claim 1, the request handler to map the handler service requests and response messages from selected destination servers to the client service request.

5. The server of claim 1, each handler identifier including a label and a function name, the function name indicative the predefined procedure implemented by the request handler corresponding to the handler identifier.

6. The server of claim 1, the response data including data indicative of success, failure, and timeout responses from the destination server.

7. The server of claim 1, each request handler send a reply message indicative of a failure to process the client service request upon expiration of a predetermined time duration.

8. The server of claim 1, the predefined procedure of each of the request handlers implemented independently of a client, the client being unaware of the sending and receiving of handler requests and response messages to and from destination servers.

9. The server of claim 1, at least one destination server being under different ownership than the server.

10. A method of operating a server comprising:
receiving client service requests, each client service request including a handler identifier;
selecting, for each client service request, a request handler corresponding to the handler identifier, the selected request handler processing the client service request by implementing a predefined procedure including:
sending a handler service request to a destination server initially selected from a predetermined group of destination servers associated with the request handler;
receiving a response message, including response data, from the initially selected destination server; and
based on the response data, determining whether the pre-defined procedure is complete; and
sending a reply message to the client if the pre-defined procedure is complete; and
sending a new handler service request to a destination server newly selected from the predetermined group of destination servers if the pre-defined procedure is not complete.

11. The method of claim 10, the destination server newly selected from the predetermined group of destination servers is the same as the initially selected destination server.

12. The method of claim 10, the destination server newly selected from the predetermined group of destination servers is different from the initially selected destination server.

13. The method of claim 10, including mapping handler service requests and response messages to and from selected destination servers to the client request.

14. The method of claim 10, the client being unaware of the processing of the client service request by the predefined procedure performed implemented by the selected request handler.

15. The method of claim 10, including deeming the predefined procedure to be complete and sending a reply message to the client indicative of a failure upon expiration of a predetermined time duration.

16. A non-transitory computer-readable storage medium comprising computer-executable instructions executable by at least one processor to implement a server to:
receive client service requests, each client service request including a handler identifier;
select, for each client service request, a request handler corresponding to the handler identifier, the selected request handler processing the client service request by implementing a predefined procedure including to:
send a handler service request to a destination server initially selected from a predetermined group of destination servers associated with the request handler;
receive a response message, including response data, from the initially selected destination server; and
based on the response data, determine whether the pre-defined procedure is complete; and
send a reply message to the client if the pre-defined procedure is complete; and
send a new handler service request to a destination server newly selected from the predetermined group of destination servers if the pre-defined procedure is not complete.

17. The non-transitory computer readable medium of claim 16, further including instructions for the request handler to map handler service requests and response messages to the client service request.

18. The non-transitory computer readable medium of claim 16, further including instructions for the request handler to send a reply message to the client indicative of a failure upon expiration of a predetermined time duration.
